(19) United States
(12) Patent Application Publication
(10) Pub. No.: US 2004/0086621 A1
(43) Pub. Date: May 6, 2004

(54) Reduced calorie fat

(75) Inventors: John Westcott Finley, Hawthorn Woods, IL (US); Peter J. Huth, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/289,112

(22) Filed: Nov. 6, 2002

(51) Int. Cl. A23D 7/00

(52) U.S. Cl. 426/601

(57) ABSTRACT

The present invention generally relates to a reduced calorie fat. More specifically, the present invention relates to a modified natural triglyceride which is metabolized less efficiently than traditional triglycerides resulting in reduced caloric intake. The triglyceride compositions of the present invention are described by the general formula:

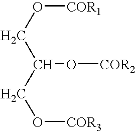

wherein —OCOR₁ and —OCOR₃ are independently substantially unsaturated long chain fatty acids having at least 16 carbon atoms and wherein R₂ is a short chain fatty acid having less than 12 carbon atoms.

### FIELD OF THE INVENTION

The present invention generally relates to a reduced calorie fat. More specifically, the present invention relates to a modified natural triglyceride which is metabolized less efficiently than traditional triglycerides resulting in reduced caloric intake.

### BACKGROUND OF THE INVENTION

Fat is an essential component of the human diet and is required for energy as well as production of cell membranes, blood lipids, bile, steroids, and Vitamin D. Chemically, fats are made from the combination of fatty acids and glycerol. The major components in most fats are triglycerides which are derived from the combination of three fatty acids and glycerol. The characteristics of the triglyceride are generally determined by the specific fatty acids in the triglyceride. For example, vegetable oils are generally composed of triglycerides appended with three long chain unsaturated fatty acids. Hard fats such as lard and butter generally contain triglycerides with high levels saturated fatty acids.

Although fats are necessary for essential bodily functions, consumption of excess fats in various foodstuffs contributes significantly to obesity. High fat diets also contribute to various human diseases such as heart and coronary diseases. One method of reducing obesity and/or diseases such as heart and coronary diseases in the human population is to reduce the consumption of fat. In recent years, fat substitutes or low-calorie fats have attracted increasing attention as a method of reducing the fat and calorie content of foodstuffs. In particular, fat substitutes or low-calorie fats which are capable of reducing caloric intake without sacrificing the functionality and organoleptic attributes associated with fat-containing foods are highly desirable.

One attempt to lower the caloric content of foods has been the production of modified fats that are partially or wholly indigestible and thus comparatively low in available calories. For example, U.S. Pat. No. 3,963,699 (Jun. 15, 1976), U.S. Pat. No. 4,005,195 (Jan. 25, 1977), U.S. Pat. No. 5,422,131 (Jun. 6, 1995), U.S. Pat. No. 5,294,451 (Mar. 15, 1994), U.S. Pat. No. 5,491,226 (Feb. 13, 1996), U.S. Pat. No. 5,518,754 (May 21, 1996), U.S. Pat. No. 5,585,132 (Dec. 17, 1996), and U.S. Pat. No. 5,968,566 (Oct. 19, 1999) describe nonabsorbable, nondigestible fat substitutes comprising certain polyol fatty acid polyesters having at least 4 fatty acid ester groups. Such fat substitutes often result in digestive problems (e.g., anal leakage) and generally only poorly mimic the organoleptic properties of natural fats.

U.S. Pat. No. 5,378,490 (Jan. 3, 1995), U.S. Pat. No. 5,258,197 (Nov. 15, 1993), U.S. Pat. No. 5,411,756 (May 2, 1995), U.S. Pat. No. 5,456,939 (Oct. 10, 1995), U.S. Pat. No. 5,552,174 (Sep. 3, 1996), U.S. Pat. No. 5,565,232 (Oct. 15, 1996), and U.S. Pat. No. 5,662,953 (Sep. 2, 1997) provide modified triglyceride fat substitutes. These fat substitutes generally are mixtures of at least two triglycerides bearing long-chain saturated fatty acid residues and short-chain fatty acid residues. The long-chain saturated fatty acids are poorly absorbed when consumed resulting in fewer available calories contributed to the diet. These fat substitutes generally have less than about 15 percent, and preferably less than about 10 percent, unsaturated fatty acids.

Diets high in saturated fat have been shown to increase the risk of heart disease. It is, therefore, desirable to provide reduced-fat triglycerides made primarily of unsaturated fatty acids. It is also desirable to provide a reduced fat triglyceride with physical and organoleptic characteristics similar to natural unsaturated fats. The present invention provides natural reduced-fat triglycerides made primary of unsaturated fatty acids. The modified fats produced by the present invention provide improved textural, organoleptic, and hydrophillic properties which closely resemble those of fats normally used in food products.

### SUMMARY OF THE INVENTION

The present invention relates to triglycerides having reduced calorie characteristics. The triglyceride compositions of the present invention are described by the general formula:

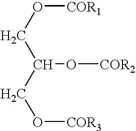

wherein —OCOR₁ and —OCOR₃ are independently substantially unsaturated long chain fatty acids having at least 16 carbon atoms and wherein —OCOR₂ is a short chain fatty acid having less than 12 carbon atoms. The fat of the current invention has flavor and texture attributes similar to that of natural vegetable oils. Additionally, the fat of the current invention may be partially hydrogenated to provide firmer texture, control melting point, and improve functionality. For purposes of this invention, “substantially unsaturated” is intended to provide for at least 20 percent of the long chain fatty acids to be unsaturated, preferably at least about 50 percent of the long chain fatty acids to be unsaturated, and more preferably at least about 80 percent of the long chain fatty acids to be unsaturated.

The fat compositions that are the subject of the current invention are generally in the form of triglycerides with a short chain fatty acid in the middle or R₂ position and long chain unsaturated fatty acids in the terminal R₁ and R₃ positions. Due to their unique structure, the fat compositions of the current invention are absorbed and metabolized less efficiently than normal triglycerides, resulting in fewer calories contributed to the diet. The caloric value of triglyceride compositions of the current invention is estimated to be about 5.9 kcal/g as compared to about 9.0 kcal/g for conventional triglycerides.

In normal fat metabolism, pancreatic enzymes remove the terminal R₁ and R₃ fatty acids leaving an R₂ monoglyceride. The R₂ monoglyceride is absorbed by the gut mucosa, and fatty acids are appended thereto to form a new triglyceride, which is then transported via the lymphatic system to other parts of the body for storage or metabolism.

When the modified triglyceride of the current invention is ingested, the short-chain fatty acid in the middle or R₂ position is rapidly hydrolyzed off by gastric enzymes resulting in a 1,3-diglyceride. The 1,3-diglyceride, unlike the R₂ monoglyceride, does not combine efficiently with free fatty acids to form new triglycerides, rather, it is hydrolyzed by the body into glycerol and free fatty acids. The free fatty acids are subsequently absorbed by the gut and transported to the liver where they are oxidized. Thus, due to their unique chemical structure, the fats of the current invention are metabolized in such a way that does not promote the storage fat by the body.

### DETAILED DESCRIPTION OF THE INVENTION

The present invention relates to triglyceride compositions having reduced calorie characteristics which are effective in promoting weight loss. The triglyceride compositions of the present invention are described by the general formula:

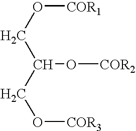

wherein —OCOR, and —OCOR₃ are independently substantially unsaturated long chain fatty acids having at least 16 carbon atoms and wherein —OCOR₂ is a short chain fatty acid having less than 12 carbon atoms. For purposes of this invention, “substantially unsaturated” is intended to provide for at least 20 percent of the long chain fatty acids to be unsaturated, preferably at least about 50 percent of the long chain fatty acids to be unsaturated, and more preferably at least about 80 percent of the long chain fatty acids to be unsaturated. Even more preferably, the triglyceride compositions of the present invention are described by the general formula:

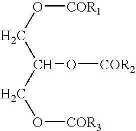

wherein —OCOR₁ and —OCOR₃ are independently unsaturated long chain fatty acids having at least 18 carbon atoms and wherein —OCOR₂ is a short chain fatty acid having less than 5 carbon atoms.

Even more preferably, the triglycerides of the present invention consists essentially of the general formula:

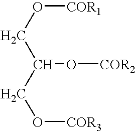

wherein —OCOR, and —OCOR₃ are independently substantially unsaturated long chain fatty acids having at least 16 carbon atoms and wherein —OCOR₂ is a short chain fatty acid having less than 12 carbon atoms.

Examples of unsaturated long-chain fatty acids that may be utilized in the R₁ and R₃ positions are oleic, linoleic, and linolenic acids. Examples of short chain fatty acids that may be utilized in the R₂ position are acetic, propanoic, and butyric acids. The triglyceride composition is designed to be less efficiently stored in the body when compared to traditional triglycerides. The caloric value of triglycerides of the current invention are estimated to be about 5.9 kcal/g as compared to about 9.0 kcal/g for normal triglycerides. Preferred triglycerides of the current invention include 1,3-dioleyl-2-acetyl glycerol and 1,3-dioleyl-2-propionylglycerol. The more preferred triglyceride is 1,3-dioleyl-2-butyrylglycerol.

The present invention also relates to food compositions containing the triglycerides as described above. Generally such food compositions contain less than about 80 percent of the present triglycerides, preferably about 5 to about 50 percent, and more preferably about 15 to about 30 percent. Thus, the present triglycerides can be substituted for other fats normally included in food compositions (e.g., soy oil, canola oil, corn oil, and the like); the present triglycerides can replace essentially all or only a portion of such other fats as desired. The present triglycerides are effective at dissolving up to about 10 percent water or glycerine/water mixtures. Inclusion of water or glycerine/water further dilutes the caloric value of the present triglycerides and does not significantly effect the performance of present triglycerides in food compositions such as, for example, dressings, confections, dairy products (e.g., yogurt, natural or processed cheese, ice cream), fillings, baked goods (e.g., cookies, crackers, sweet goods, and the like). The present triglycerides could also be used as cooking oils or vegetable oil.

The triglycerides of the current invention may be produced be produced by two-step process by which 1,3-diglycerides having long chain fatty acids are first produced and further processed to append the short chain fatty acid. To produce the 1,3-diglyceride, any of several technologies including chemical synthesis, conventional lipase, or unique Sn2 specific lipase may be used. The resulting diglyceride are then acylated with acetic, propionic or butyric anhydride. Alternatively, acylation can be accomplished using the acid resulting triglyceride can be hydrogenated to various degrees to control the functionality.

The following example is included to illustrate the invention and not to limit it. Unless otherwise indicated, all percentages are by weight. All patents and references cited in the present specification are hereby incorporated by reference.

### EXAMPLE

A commercial diglyceride (25 ml; Econa Cooking Oil, Kao Corp., Japan) was refluxed for two hours with 5 ml of butyric anhydride. The resulting material was steam distilled for two hours under house vacuum to remove excess butyric acid. About 18 g of a modified oil (about 70 percent triglyceride having long chain unsaturated fatty acids in the 1 and 3 positions and butyrate in the 2 position and about 30 percent triglyceride having long chain unsaturated fatty acids in the 2 and 3 positions and butyrate in the 1 position) was recovered.

A similar product was prepared by reacting acetic anhydride (5 ml) as the acylating agent with the same commercial diglyceride (25 ml) under similar conditions. About 14 g of a modified oil (about 70 percent triglyceride having long chain unsaturated fatty acids in the 1 and 3 positions and acetate in the 2 position and about 30 percent triglyceride having long chain unsaturated fatty acids in the 2 and 3 positions and acetate in the 1 position) was recovered.

Product identity of both oils were confirmed using NMR. Both products can be incorporated into food products in replace natural fats and provide lower calorie products.

1. A triglyceride having reduced calorie characteristics which are effective in promoting weight loss, said triglyceride comprising the formula 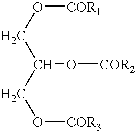
wherein —OCOR₁ and —OCOR₃ are independently substantially unsaturated long chain fatty acids having at least 16 carbon atoms and wherein —OCOR₂ is a short chain fatty acid having less than 12 carbon atoms;
whereby the triglyceride composition has reduced calorie characteristics which are effective in promoting weight loss.

2. The triglyceride as described in claim 1, wherein —OCOR₁ and —OCOR₃ are independently selected from the group consisting of oleic acid, linoleic acid, and linolenic acid.

3. The triglyceride as described in claim 1, wherein —OCOR₂ is selected from the group consisting of acetic acid, propionic acid, and butyric acid.

4. The triglyceride as described in claim 2, wherein —OCOR₂ is selected from the group consisting of acetic acid, propionic acid, and butyric acid.

5. The triglyceride as described in claim 1, wherein —OCOR₁ and —OCOR₃ are oleic acid and wherein —OCOR₂ is selected from the group consisting of acetic acid, propionic acid, and butyric acid.

6. A triglyceride having reduced calorie characteristics which are effective in promoting weight loss, said triglyceride comprising the formula 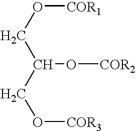
wherein —OCOR₁ and —OCOR₃ are independently substantially unsaturated long chain fatty acids having at least 16 carbon atoms and wherein —OCOR₂ is a short chain fatty acid having less than 12 carbon atoms;
whereby the triglyceride composition has reduced calorie characteristics which are effective in promoting weight loss.

7. The triglyceride as described in claim 6, wherein —OCOR, and —OCOR₃ are independently selected from the group consisting of oleic acid, linoleic acid, and linolenic acid.

8. The triglyceride as described in claim 6, wherein —OCOR₂ is selected from the group consisting of acetic acid, propionic acid, and butyric acid.

9. The triglyceride as described in claim 7, wherein —OCOR₂ is selected from the group consisting of acetic acid, propionic acid, and butyric acid.

10. The triglyceride as described in claim 6, wherein —OCOR₁ and —OCOR₃ are oleic acid and wherein —OCOR₂ is selected from the group consisting of acetic acid, propionic acid, and butyric acid.

11. A low calorie food composition containing less than about 80 percent of a triglyceride having reduced calorie characteristics which are effective in promoting weight loss, wherein the triglyceride comprises the formula 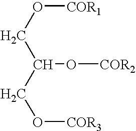
wherein —OCOR₁ and —OCOR₃ are independently substantially unsaturated long chain fatty acids having at least 16 carbon atoms and wherein —OCOR₂ is a short chain fatty acid having less than 12 carbon atoms;
whereby the triglyceride has reduced calorie characteristics which are effective in promoting weight loss.

12. The low calorie food composition as described in claim 11, wherein the food composition contains about 5 to about 50 percent of the triglyceride.

13. The low calorie food composition as described in claim 11, wherein the food composition contains about 15 to about 30 percent of the triglyceride.

14. The low calorie food composition as described in claim 11, wherein —OCOR, and —OCOR₃ are independently selected from the group consisting of oleic acid, linoleic acid, and linolenic acid.

15. The low calorie food composition as described in claim 11, wherein —OCOR₂ is selected from the group consisting of acetic acid, propionic acid, and butyric acid.

16. The low calorie food composition as described in claim 14, wherein —OCOR₂ is selected from the group consisting of acetic acid, propionic acid, and butyric acid.

17. The low calorie food composition as described in claim 11, wherein —OCOR₁ and —OCOR₃ are oleic acid and wherein —OCOR₂ is selected from the group consisting of acetic acid, propionic acid, and butyric acid.

18. The low calorie food composition as described in claim 13, wherein —OCOR, and —OCOR₃ are independently selected from the group consisting of oleic acid, linoleic acid, and linolenic acid.

19. The low calorie food composition as described in claim 13, wherein —OCOR₂ is selected from the group consisting of acetic acid, propionic acid, and butyric acid.

20. The low calorie food composition as described in claim 18, wherein —OCOR₂ is selected from the group consisting of acetic acid, propionic acid, and butyric acid.

21. The low calorie food composition as described in claim 13, wherein —OCOR₁ and —OCOR₃ are oleic acid and wherein —OCOR₂ is selected from the group consisting of acetic acid, propionic acid, and butyric acid.
